(19) United States
(12) Patent Application Publication
(10) Pub. No.: US 2021/0291036 A1
(43) Pub. Date: Sep. 23, 2021

(54) SITUATIONALLY UNIQUE PRINTING EVENTS

(71) Applicant: Hewlett-Packard Development Company, L.P., Spring, TX (US)

(72) Inventors: Evan Scheessele, Corvallis, OR (US); Allen Owen Wright, Corvallis, OR (US); Krishna Prasad Muraleedharan Pillai, Corvallis, OR (US)

(73) Assignee: Hewlett-Packard Development Company, L.P., Spring, TX (US)

(21) Appl. No.: 17/262,425

(22) PCT Filed: Nov. 2, 2018
(86) PCT No.: PCT/US2018/058878

§ 371 Date: Jan. 22, 2021

(51) Int. Cl. A63F 9/24; A63F 1/06; G06K 9/00

(52) U.S. Cl. CPC A63F 9/24; A63F 1/06; G06K 2009/00738; A63F 2009/2455; A63F 2009/2435; G06K 9/00711

(57) ABSTRACT

An example apparatus includes: a communication interface to communicate with a camera and a printer; and a processor connected to the communication interface and a memory storing rules of an event that relies on printed materials, the processor to execute instructions stored in the memory. The instructions are to: monitor, using the camera, a live instance of the event that relies on the printed materials; determine, from images acquired by the camera, that a sequence of the printed materials used in the event by participants meets a threshold condition that conforms to the rules of the event; and, in response, control the printer to print additional printed material that conforms to the rules of the event, as stored in the memory, the additional printed material used to alter the event according to the rules, the additional printed material unassigned to any of the participants in the event.

### BACKGROUND

Events involving exchange of printed material, and/or use of printed material, involving rules, for example, in card games and/or games based on figurines, generally occur using strictly human based decisions that occur according to the rules. As card based gaming (e.g. using cards other than a deck of French playing cards used in casinos and the like) is becoming more popular, the full possibility of such gaming may not be fully reached, which could lead to a flattening of interest.

### BRIEF DESCRIPTION OF THE DRAWINGS

Reference will now be made, by way of example only, to the accompanying drawings in which:

FIG. 1 is a block diagram of an example device that provides situationally unique printing events;

FIG. 2 is a block diagram of an example system that provides situationally unique printing events;

FIG. 3 shows examples of printed materials used to generate situationally unique printing events;

FIG. 4 is a flowchart of an example method to provide situationally unique printing events;

FIG. 5 is a block diagram of another example system that provides situationally unique printing events;

FIG. 6 is a block diagram of another example system that provides situationally unique printing events;

FIG. 7 is a block diagram of another example system that provides situationally unique printing events;

FIG. 8 is a block diagram of another example system that provides situationally unique printing events;

FIG. 9 is a block diagram of another example system that provides situationally unique printing events.

### DETAILED DESCRIPTION

Card based gaming, and figurine-based gaming, such as adventure and/or role-playing gaming, is becoming more popular. Such gaming relies on rules that the users must adhere to when playing the game. However, different from games that involve a deck of French playing cards, where the number of type of cards is limited, role-playing games often use expansion decks, and the like, where the types of unique cards used in the game are being constantly expanded; similarly, figurine-based role-playing games may start with a limited set of figures, but again the types of unique figurines may be expanded through release of new figurines.

However, such a scheme for expanding the scope of the games is limited as they rely on a company printing the expansion cards and/or manufacturing the figurines and releasing them for sale. Hence, the scope of game play is generally controlled by the company and may further rely on the players of the game purchasing and using the expansion cards and/or figurines. Such a scheme may lead to the full possibility of such gaming not being fully reached, which could lead to a flattening of interest.

Hence, provided herein is a device, system and method for providing situationally unique printing events, which may be two-dimensional and/or three-dimensional printing events. In general, a device has access to a two-dimensional and/or three-dimensional printer, as well as a camera used to monitor a live instance of an event that relies on rules, such as a role-based game, an adventure game and the like. The device further has access to a memory that stores rules of the event. The device determines from images acquired by the camera, that a sequence of the printed materials used in the event by participants meets a threshold condition that conforms to the rules. In response, the device controls the printer to print additional printed material that conforms to the rules, and which are used to alter the event according to the rules. The additional printed materials are generally unassigned to any of the participants in the event; rather, the device itself may be virtual participant in the event, and/or a virtual gamemaster of the event, which is used to alter game play.

For example, the device may monitor a game and, in response to a threshold condition detected in the game, control a printer to print a card and/or a figurine that changes the game play, for example to introduce an unexpected aspect to the game that would not occur with use of expansion decks and/or a pre-purchase of a figurine. Indeed, in some examples, the device could change the rules of the game.

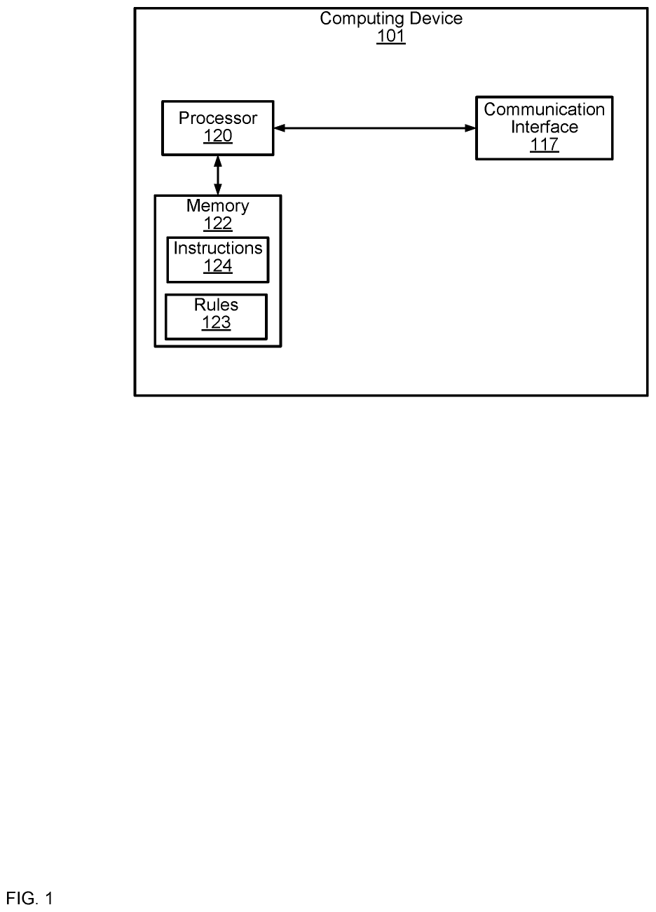

Referring to FIG. 1, a computing device 101 to provide situationally unique printing events is depicted schematically. The computing device 101 comprises: a communication interface 117 to communicate with a camera (not depicted) and a printer (not depicted); and a processor 120 connected to the communication interface 117 and a memory 122 storing rules 123 of an event that relies on printed materials, the processor 120 to execute instructions 124 stored in the memory 122, the instructions 124 to: monitor, using the camera, a live instance of the event that relies on the printed materials; determine, from images acquired by the camera, that a sequence of the printed materials used in the event by participants meets a threshold condition that conforms to the rules of the event, as stored in the memory; and, in response, control the printer to print additional printed material that conforms to the rules of the event, as stored in the memory, the additional printed material used to alter the event according to the rules, the additional printed material unassigned to any of the participants in the event.

For example, the computing device 101, interchangeably referred to hereafter as the device 101, may comprise a server and/or a personal computer and/or a laptop computer and/or a mobile computing device.

The event monitored by the device 101 may comprise a game, such as a role-playing game, an adventure-based game, and the like, which relies on special purpose printed material. In particular, the printed material used in the monitored event is generally specific to the event and may be cards and/or figurines used in a wide variety of role-based and/or adventure based card games and/or figurine-base games. Indeed, the printed material used in the monitored event is generally expandable, and hence the events and/or the games and/or the printed material excludes French-deck based games and/or French decks, which has a fixed number and type of cards.

Indeed, in some examples, the printed materials used in the event are playing cards, and the additional printed material includes an additional playing card (e.g. similar to an expansion deck card), which may be different from other playing cards currently in play in the event. In such examples, the printer with which the device 101 communicates includes a two-dimensional printer.

However, in other examples, the printed materials used in the event are three-dimensional figures, and the additional printed material includes an additional three-dimensional figure. In such examples, the printer with which the device 101 communicates includes a three-dimensional printer.

The memory 122 is coupled to the processor 120 and includes a non-transitory machine-readable storage medium that may be any electronic, magnetic, optical, or other physical storage device. The non-transitory machine-readable storage medium of the memory 122 may include, for example, random access memory (RAM), electrically-erasable programmable read-only memory (EEPROM), flash memory, a storage drive, an optical disc, and the like. The memory 122 may also be encoded with executable instructions to operate the communication interface 117 and other hardware in communication with the processor 120.In other examples, it is to be appreciated that the memory 122 may be substituted with a cloud-based storage system.

The memory 122 may also store an operating system that is executable by the processor 120 to provide general functionality to the device 101, for example, functionality to support various applications such as a user interface to access various features of the device 101. Examples of operating systems include a Real-Time Operating System (RTOS). Windows™, macOS™, iOS™, Android™, Linux™, and Unix™. The memory 122 may additionally store applications that are executable by the processor 120 to provide specific functionality to the device 101, such as those described in greater detail below and which may include the instructions 124.

The processor 120 may include a central processing unit (CPU), a microcontroller, a microprocessor, a processing core, a field-programmable gate array (FPGA), or similar. The processor 120 and memory 122 may cooperate to execute various instructions such as the instructions 124.

In some of these examples, the processor 120 and/or the instructions 124 may also be to: determine, from the images acquired by the camera, the sequence of the printed materials from a backside of each of the printed materials, the backside of each of the printed materials comprising an indication of a respective face side of the printed materials. Such an indication may include, barcode, alphanumeric code, and the like and/or special symbols and/or indications viewable via light that is not visible to a human vision system (e.g. indications printed with infrared light and/or ultra-violet light emitting ink; in such examples, the camera printer with which the device 101 communicates includes an infrared camera and/or an ultra-violet camera).

However, in some of these examples, the processor 120 and/or the instructions 124 may also be to: determine, from the images acquired by the camera, the sequence of the printed materials from a backside or a face side of each of the printed materials, the backside of each of the printed materials comprising an indication of a respective face side of the printed materials.

In some of these examples, the processor 120 and/or the instructions 124 may also be to: monitor a state of the event based on the printed materials used in the event, the threshold condition related to the state of the event.

In some of these examples, the processor 120 and/or the instructions 124 may also be to: control the printer to print additional printed material that conform to the rules 123 of the event, as stored in the memory 122, the additional printed material used to alter the event according to the rules 123 and according to information printed on the additional printed material, the additional printed material unassigned to any participants in the event.

In some of these examples, the processor 120 and/or the instructions 124 may also be to: determine the information printed on the additional printed material based on the sequence of the printed materials.

In some of these examples, the processor 120 and/or the instructions 124 may also be to: determine the information printed on the additional printed material based on the sequence of the printed materials and the rules 123 of the event, as stored in the memory 122, the information to trigger a given state of the event.

In some of these examples, the processor 120 and/or the instructions 124 may also be to: monitor a state of the event based on the printed materials used in the event, the threshold condition related to the state of the event.

In some of these examples, the processor 120 and/or the instructions 124 may also be to: monitor a state of the event based on the printed materials used in the event, the threshold condition related to the state of the event, the state of the event being a final phase of the event.

In some of these examples, the processor 120 and/or the instructions 124 may also be to: control the printer to print additional printed material that conforms to the rules 123 of the event, as stored in the memory 122, the additional printed material used to change the rules of the event; and store changed rules of the event in the memory 122.

In some of these examples, the processor 120 and/or the instructions 124 may also be to: determine, from images acquired by the camera, that the rules of the event or the changed rules of the event are being violated; and, in response, control the printer to provide an alert.

In some of these examples, the processor 120 and/or the instructions 124 may also be to: control the printer to interrupt the event by providing a notification.

In some of these examples, the communication interface 117 may be further to communicate with an augmented reality device used by a participant in the event. In these examples, the processor 120 and/or the instructions 124 may also be to: control the augmented reality device to provide an animation of the printed materials used in the event.

The instructions 124 may include machine learning algorithms and/or deep learning algorithms trained to determine, from images acquired by the camera, that a sequence of the printed materials used in the event by participants meets a threshold condition that conforms to the rules 123 of the event. The machine learning algorithms and/or deep learning algorithms of the instructions 124 may be further trained to determine which additional printed material to print. The machine learning algorithms and/or deep learning algorithms of the instructions 124 may be further trained to determine information to be printed on the printed material. The machine learning algorithms and/or deep learning algorithms of the instructions 124 may be further trained to determine how to change the rules 123 of the event. Indeed, any suitable functionality of the device 101 that includes decision making based on images from a camera may be implemented via machine learning algorithms and/or deep learning algorithms trained to implement such functionality, for example in an initial training mode, further training modes, and/or based on feedback provided to the device 101.

The machine learning algorithms and/or deep learning algorithms of the instructions 124 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like. However, any suitable machine learning algorithms and/or deep learning algorithms are within the scope of the present specification.

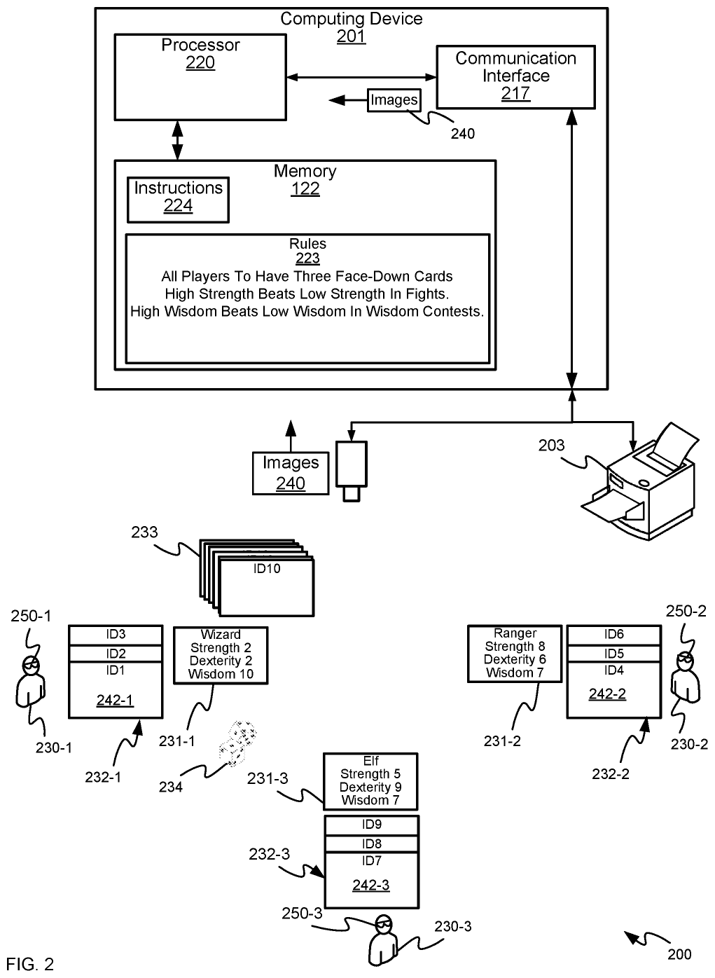

Attention is next directed to FIG. 2 which depicts a schematic block diagram of a system 200 that includes a computing device 201 interchangeably referred to hereafter as the device 201. The system 200 further comprises a camera 202 and a printer 203.

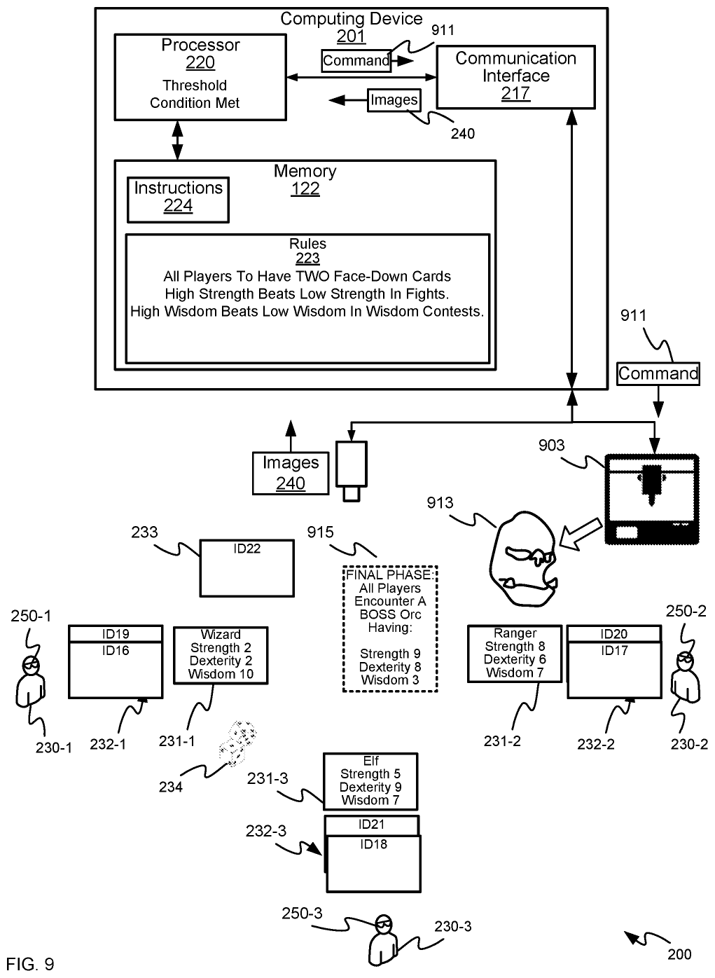

The camera 202 may comprise any suitable digital camera and/or video camera. As depicted, the printer 203 comprises a two-dimensional printer. Examples of systems that include a three-dimensional printer are described below with respect to FIG. 9. However, the system 200 may include both the two-dimensional printer and a three-dimensional printer.

The device 201 is similar to the device 101, with like components having like numbers, however in a “200” series rather than a “100” series. Hence, the device 201 comprises: a communication interface 217 to communicate with the camera 202 and the printer 203; and a processor connected to the communication interface 217 and a memory 222 storing rules 223 of an event that relies on printed materials, the processor 220 to execute instructions 224 stored in the memory 222. Various aspects of the device 201 are described hereafter, for example while the device 201 is understood to be executing the instructions 224.

Communication links between the various components of the system 200 are depicted as double-ended arrows. For example, the communication interface 217 is to communicate with the camera 202 and the printer 203 in a wireless or wired manner as desired, and the communication links therebetween may bence be wireless or wired as desired, with the communication interface 217, the camera 202 and the printer 203 adapted accordingly. For example, the communication interface 217, the camera 202 and the printer 203 may be adapted to communicate via cables, WiFi networks, Bluetooth™ networks, Zigbee™ networks, the Internet, cell phone networks, local area networks (LANs), and the like. In some examples, the device 201 may be co-located with the camera 202 and the printer 203, and in other examples, the device 201 may be remote from (e.g. not in same room as) the camera 202 and the printer 203.

In yet further examples, the device 201 may be integrated with the camera 202 or the printer 203. In yet further examples, the device 201, the camera 202 and the printer 203 may be integrated into one unit.

As depicted, the camera 202 and the printer 203 are co-located in location where participants 230-1, 230-2, 230-3 are participating in an event that relies on printed materials. The participants 230-1, 230-2, 230-3 are interchangeably referred to hereafter, collectively, as the participants 230 and, generically, as a participant 230.

As depicted, the event comprises a role-playing and/or adventure game where the printed materials are playing cards (and/or, alternatively, figurines). For example, as depicted, each participant 230 has played one respective face-up card 231-1, 231-2, 231-3 and a plurality of face-down cards 232-1, 232-2, 232-3 (interchangeably referred to hereafter, collectively, as the face-down cards 232 and, generically, as a face-down card 232). The face-up card 231-1, 231-2, 231-3 are interchangeably referred to hereafter, collectively, as the face-up cards 231 (and/or the cards 231) and, generically, as a face-up card 231 (and/or a card 231). Similarly, The face-down card 232-1, 232-2, 232-3 are interchangeably referred to hereafter, collectively, as the face-down cards 232 (and/or the cards 232) and, generically, as a face-down card 232 (and/or a card 232).

As depicted, each of the participants 230 have three face-down cards 232 and one face-up card 231.

Furthermore, the event includes a draw deck of cards 233 in a face-down position.

Furthermore, as depicted, the event may include use of dice 234, for example for use in “fights” and/or “contests” in the event.

While not depicted, the participants 230 may also track “health”, and the like, of characters represented by the face-up cards 231; the health of the characters may also be tracked using the device 201.

In general, the camera 202 is positioned such that the cards 231, 232, 233 (and the dice 234, if used) being used in the game are in a field of view of the camera 202. For example, the cards 231, 232, 233 may be placed on a table, and the like, and the camera 202 is positioned such that the cards 231, 232, 233 (and the dice 234, if used) are in the field of view of the camera 202. The camera 202 generally provides images 240 of the cards 231, 232, 233 being used in the game to the processor 220 via the communication interface 217, such that the processor 220, implementing the instructions 224, may control the printer 203 accordingly, as described in more detail below.

As depicted, each of face sides of the face-up cards 231 includes information that defines a respective character in the game, as well as characteristics of the character; for example, the face-up card 231-1 is representative of a “Wizard” having “Strength” of “2”, “Dexterity” of “2” and “Wisdom” of 10. The other face-up cards 231 define other characters and their respective characteristics. The characteristics printed on the face sides of the face-up cards 231 may generally represent information used in the game for the characters to fight each other and/or for the characters to band together to fight other characters. Furthermore, each of the characters represented by the face-up cards 231 may represent each of the respective participants 230 roles in the game and/or each of the characters represented by the face-up cards 231 may represent a temporary role of the respective participants 230 roles in the game. For example the characters represented by the face-up cards 231 may represent each of the respective participants 230 roles for the entirety of the game, or for a round of the game.

As depicted, each of backsides of the cards 232, 233 includes an indication of a respective face side of the cards 232, 233. For example, a backside each of the cards 232, 233 includes a respective identifier “ID#” which may be a barcode, an alphanumeric code, and/or a code printed with infrared and/or ultraviolet ink, and the like, indicative of a face side of the cards 232, 233. Regardless, indications “ID#” do not allow the participants 230 to know the information on the face side of the cards 232, 233.

Each of the cards 232, 233 may represent a card that includes instructions on a respective face side that the participants 230 are to follow when a card 232, 233 is played and/or turned over, and the respective identifier on the backside may have that information encoded therein (e.g. in the form a barcode and the like) and/or the respective identifier may be stored in the memory 222 in association with the instructions.

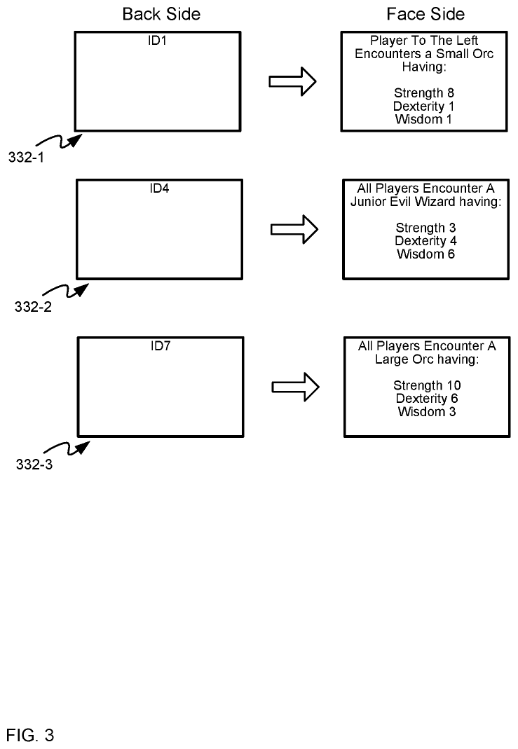

With brief reference to FIG. 3, a backside and a face side of three example face-down cards 242-1, 242-2, 242-3 are depicted. The face-down cards 242-1, 242-2, 242-3 interchangeably referred to hereafter, collectively, as the face-down cards 242 and, generically, as a face-down card 242. In particular, each of the face-down cards 242 shown in FIG. 3 comprise a face-down card 232 at the top of the respective face-down cards 232 depicted in FIG. 2.

The backside of the face-down card 242-1 has an indication of “ID1” and corresponds to the top card of the face-down cards 232-1 of the participant 230-1. The face side of the face-down card 242-1 has instructions printed thereon, of “Player To The Left Encounters A Small Orc Having Strength 8 Dexterity 1 Wisdom 1”. The indication “ID1” printed on the backside may comprise the same instructions printed on the face side, but may be printed in infrared ink, encoded in a barcode, and the like. The indication “ID1”, however, may be unique to the face-down card 242-1 within all the cards played in the game and be indicative of the instructions on the face side. In particular, the instructions are for the player (e.g. a participant 230) to the left of a player playing the card 242-1 to “fight” the “Small Orc” for example via the character on a respective face-up card 231.

Similarly, the backside of the face-down card 242-2 has an indication of “ID4” and corresponds to the top card of the face-down cards 232-2 of the participant 230-2. The face of the face-down card 242-2 has instructions printed thereon, of “All Players Encounter A Junior Evil Wizard Having Strength 3 Dexterity 3 Wisdom 6”. The indication “ID4” printed on the backside may comprise the same instructions printed on the face side, but may be printed in infrared ink, encoded in a barcode, and the like. The indication “ID4”, however, may be unique to the face-down card 242-2 within all the cards played in the game and be indicative of the instructions on the face side. In particular, the instructions are for all the players (e.g. all participants 230) to band together to “fight” the “Junior Evil Wizard” for example via the characters on the respective face-up cards 231.

Similarly, the backside of the face-down card 242-3 has an indication of “ID7” and corresponds to the top card of the face-down cards 232-3 of the participant 230-3. The face of the face-down card 242-3 has instructions printed thereon, of “All Players Encounter A Large Orc Having Strength 10 Dexterity 6 Wisdom 3”. The indication “ID7” printed on the backside may comprise the same instructions printed on the face side, but may be printed in infrared ink, encoded in a barcode, and the like. The indication “ID7”, however, may be unique to the face-down card 242-3 within all the cards played in the game and be indicative of the instructions on the face side. In particular, the instructions are for all the players (e.g. all participants 230) to band together to “fight” the “Large Orc” for example via the characters on the respective face-up cards 231.

Hence, game play may proceed by the participants 230 playing the face-down cards 232 (e.g. flipping them over the face-down cards 242 at the top of each of the face-down cards 232 to show their face sides), following the instructions on the face sides of the flipped over face-down cards 232, and drawing another card from the cards 233 in the draw deck.

In particular, game play may proceed by the participants 230 playing, in a sequence, each of the face-down cards 242-1, 242-2, 242-3. Furthermore, the images 240 received by the device 201 from the camera 202 enable the device 201 to determine a sequence of the face-down cards 242-1, 242-2, 242-3 that will be played via the identifiers printed on the backside of each of the face-down cards 242-1, 242-2, 242-3.

Furthermore, returning to FIG. 2, the rules 223 generally define the game play of the game. For example, as depicted, the rules 223 include three example rules that define “All Players To Have Three Face-Down cards”, “High Strength Beats Low Strength In Fights”, “High Wisdom Beats Low Wisdom In Wisdom Contests”.

Hence, for example, the participant 230-1 may play (e.g. turn over) the face-down card 242-1, and the participant 230-2 (e.g. the participant 230-2 is to the left of the participant 230-1) must “fight” the “Small Orc” according to the rule “High Strength Beats Low Strength In Fights”. In this example, the player 230-2 would “fight” by the character of the face-up card 231-2 fighting against the character of the card 232-1. However, the character of the face-up card 231-2 may lose such a fight as the character of the face-up card 231-2 has lower strength than the character of the card 232-1. However, the outcome of the fight may also be affected by rolling the dice 234 which may add (or subtract) to the strength of the character of the card 232-1, and the like. When the character of the face-up card 231-2 loses the fight, the character may responsively lose “Health” and/or the participant 230-2 may lose a round of the game.

Similarly, after the participant 230-1 plays the face-down card 242-1, the participant 230-1 would select another card 233 from the draw deck to ensure conformance with the rule “All Players To Have Three Face-down cards”, assuming that the face-down card 242-1 is discarded.

Game play would then proceed to the participant 230-2 playing the facedown card 242-2 and all the characters of the cards 231 would “fight” the “Junior Wizard”, with use of the dice 234 being optional. Whether the characters of the cards 231 win or lose would again depend on the rules 223 in which “High Strength Beats Low Strength In Fights” and “High Wisdom Beats Low Wisdom In Wisdom Contests”; indeed, the characters of the cards 231 may “fight” the “Junior Wizard” on the basis of “Strength” and/or “Wisdom” (and optionally “Dexterity”). In any event, the rules 223 depicted in FIG. 2 are not meant to be exhaustive, but merely representative of a larger set of rules used to play the game and/or define the event. Game play would then proceed to the participant 230-3 playing the facedown card 242-3 and all the characters of the cards 231 would “fight” the “Large Orc”, with use of the dice 234 being optional, again according to the rules 223.

During game play, the device 201 may determine, from the sequence of cards 242-1, 242-2, 242-3 to played, that a threshold condition is met and control the printer 203 to print additional printed material that conforms to the rules 223 of the event, as stored in the memory 222, the additional printed material used to alter the event according to the rules, the additional printed material unassigned to any of the participants 230 in the event.

For example, as described in more detail below, the additional printed materials may assign more health and/or strength and/or dexterity, and the like, to the characters of the cards 231, participants, for use in fights, etc. Alternatively, the additional printed materials may comprise a card that the characters of the cards 231 of the cards 231 may fight, for example in a final phase of the game and/or event. As such, the device 201 may be further to determine a state of the game and/or event, via the images 240 such that the device 201 may determine when the game and/or event is in an end-phase. Various examples of such printed material are provided below.

It is understood that while particular examples of an event are provided herein with respect to the game described in FIG. 2 and FIG. 3, any types of suitable events that rely on printed materials (e.g. that exclude French decks, and the like) and rules are within the scope of the present specification, and which may or may not include games.

Furthermore, in some examples, as also depicted in FIG. 2, the participants 230 may be wearing a respective augmented reality device 250-1, 250-2, 250-3 (interchangeably referred to hereafter, collectively as the augmented reality devices 250 and, generically, as an augmented reality device 250). The communication interface 217 may be further to communicate with an augmented reality device 250 used by a participant 230 in the event, and wherein the instructions 224 may be further to: control the augmented reality device 250 to provide an animation of printed materials used in the event. While communications links between the device 201 (e.g. the communication interface 217) and the augmented reality devices 250 are not depicted, they are nonetheless present and may be wired or wireless as desired.

As described hereafter, the device 201 may monitor the event and/or the game via the images 240 and responsively control the printer 203 according to threshold conditions as described hereafter.

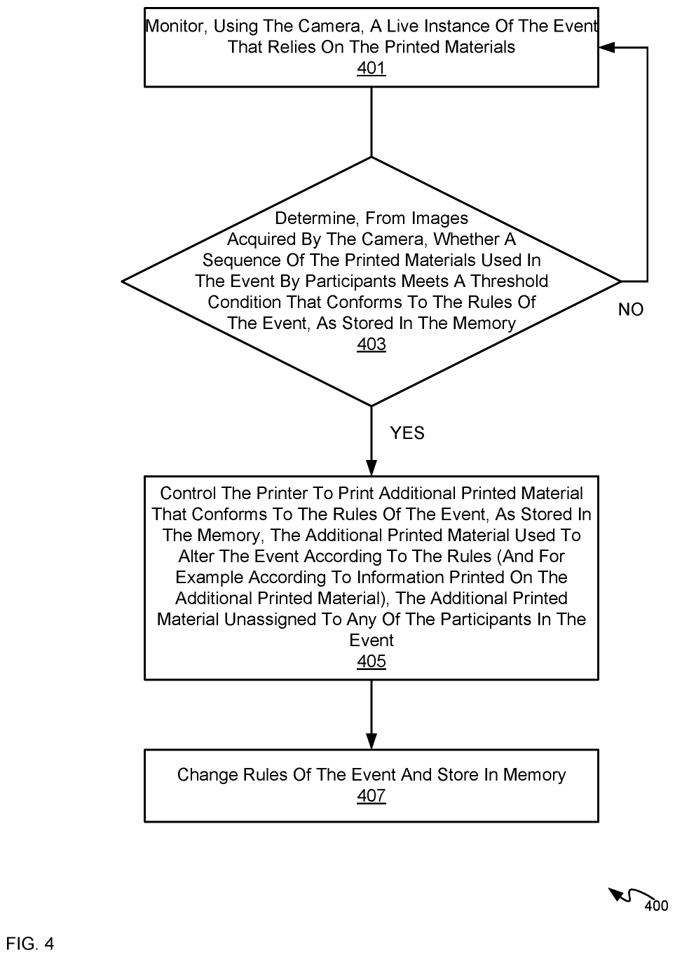

Referring to FIG. 4, a flowchart of a method 400 for situationally unique printing events is depicted. In order to assist in the explanation of method 400, it will be assumed that method 400 may be performed with the device 201, and specifically by the processor 220 implementing the instructions 224. Indeed, the method 400 may be one way in which the device 201 provides situationally unique printing events. Furthermore, the following discussion of method 400 may lead to a further understanding of the processor 220, the device 201 and its various components, as well as the system 200. Furthermore, it is to be emphasized, that method 400 may not be performed in the exact sequence as shown, and various blocks may be performed in parallel rather than in sequence, or in a different sequence altogether.

Furthermore, the method 400 may also be implemented by the device 101 using the processor 120 and may be one way in which the device 101 provides situationally unique printing events.

Beginning at a block 401, the processor 220 monitors, using the camera 202, a live instance of the event that relies on printed materials. For example, the block 401 may include the processor 220 receiving the images 240 and processing the images 240.

At a block 403, the processor 220 determines, from the images 240 acquired by the camera 202, whether a sequence of the printed materials used in the event by the participants 230 meets a threshold condition that conforms to the rules 223 of the event, as stored in the memory 222. The block 403 may include the processor 220 implementing a machine learning algorithm, and the like, of the instructions 224 to determine whether a threshold condition is met.

When the threshold condition is not met (e.g. a “NO” decision at the block 403), the processor 220 continues to monitor the event at the block 401.

However, when the threshold condition is met (e.g. a “YES” decision at the block 403), at a block 405, the processor 220 responsively, controls the printer 203 to print additional printed material that conforms to the rules 223 of the event, as stored in the memory 222, the additional printed material used to alter the event according to the rules 223, the additional printed material unassigned to any of the participants in the event. For example, at the block 405, the additional printed materials may alter the event according to information printed on the additional printed materials; however, the printed materials may not include printed information, but may be associated with information that alters the event, for example as also stored in the memory 222 and which may be provided in another format, for example in the augmented reality devices 250, and the like.

In some examples, as an alternative to the block 405 and/or in addition to the block 405 (as depicted), at a block 407, the processor 220 may change the rules 223 of the event and store changed rules in the memory 222. When the blocks 401, 403, 405 are next implemented, the blocks 401, 403, 405 implemented according to the changed rules.

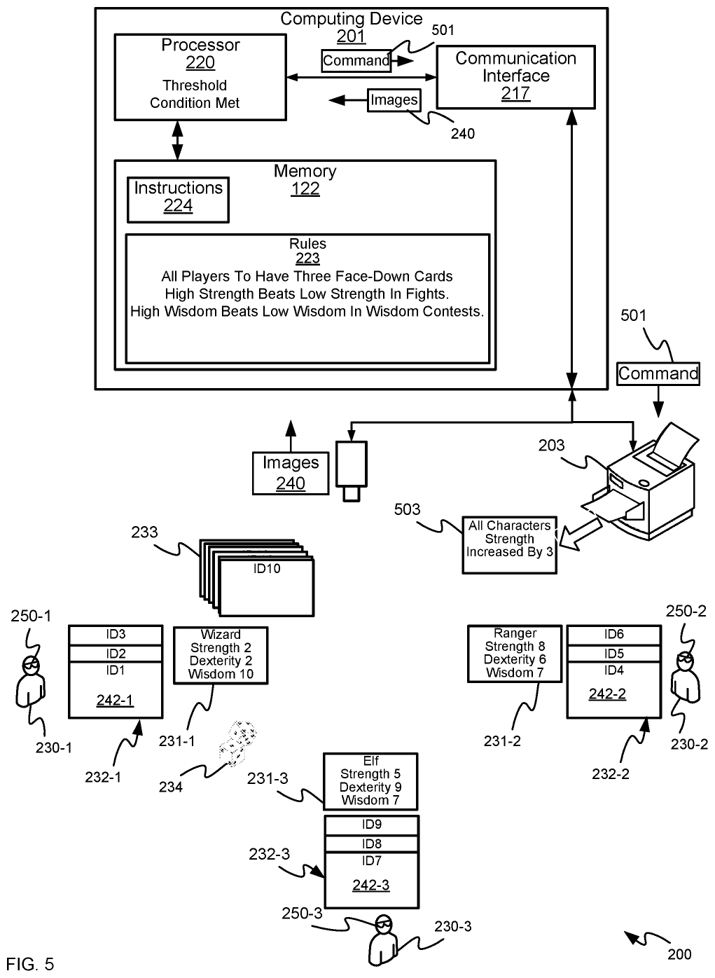

Attention is next directed to FIG. 5 which depicts an example of the method 400. FIG. 5 is substantially similar to FIG. 2 with like components having like numbers. In FIG. 5, the processor 220 is receiving the images 240 (e.g. at the block 401 of the method 400) and determines that when the sequence of cards 242-1, 242-2, 242-3 are played, there may be a high probability that the characters of the cards 231 may all “die” (e.g. in fights) and hence the game may end prematurely. As such, as depicted in FIG. 5, the processor 220 determines that a threshold condition has been met (e.g. a “YES” decision occurs at the block 403 of the method 400) and transmits a print command 501 to the printer 203 to control the printer 203 (e.g. at the block 405 of the method 400) to print additional printed material 503 that conforms to the rules 223 of the event.

As depicted, in FIG. 5, the printer 203 responsively prints the additional printed material 503 in the form of a card with the instruction of “All Characters Strength Increased by 3”. As such, the additional printed material 503 may be placed on the table with the cards 231 such that when the sequence of cards 242-1, 242-2, 242-3 are played the various “fights” that ensue may have a higher probability of being winnable (e.g. according to the rule 223 of “High Strength Beats Low Strength In Fights”) due to the characters of the cards 231 having more “Strength” according to the additional printed material 503. Furthermore, it is understood that the command 501 has encoded therein instructions for printing the additional printed material 503.

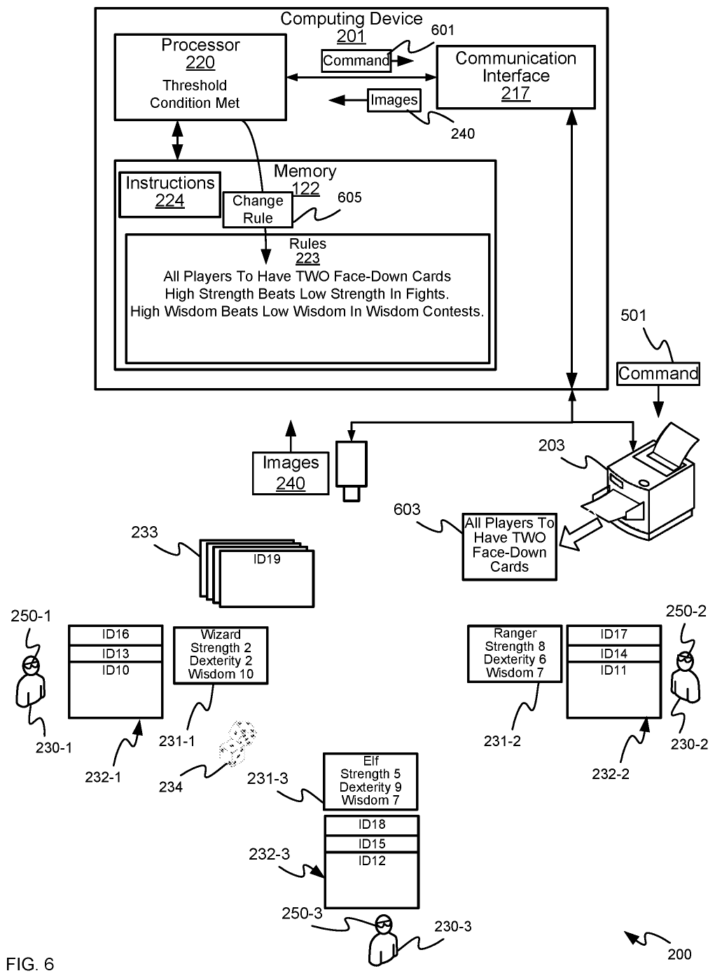

Attention is next directed to FIG. 6 which depicts another example of the method 400. FIG. 6 is substantially similar to FIG. 2 with like components having like numbers. In FIG. 6, the processor 220 is receiving the images 240 (e.g. at the block 401 of the method 400). However, in this example, game play has continued, relative to FIG. 5, and the participants 230 have continued to play the cards 232 and pick up cards 233 from the draw deck.

The images 240 may indicate that the cards 233 in the draw deck have been reduced to a number below a threshold number (e.g. as depicted there are four cards 233 left in the draw deck and hence the threshold number may be five cards 233 in the draw deck). Hence, the processor 220 may determine that, in order to extend game play after a current sequence of cards 232 are played, the participants 230 may reduce a number (e.g. that each of the participants 230 are required to have) of face-down cards 232 to two (e.g. after playing a next top card 232, a participant need not pick up a card 233 from the draw deck).

As such, as depicted in FIG. 6, the processor 220 determines that a threshold condition has been met (e.g. a “YES” decision occurs at the block 403 of the method 400 when it is determined that a sequence of cards 232 are to be played and there are four cards 233 left in the draw deck) and transmits a print command 601 to the printer 203 to control the printer 203 (e.g. at the block 405 of the method 400) to print additional printed material 603 that change the rules 223 of the event (e.g. at the block 407 of the method 400).

As depicted, in FIG. 6, the printer 203 responsively prints the additional printed material 603 in the form of a card with the instruction of “All Players To Have TWO Face-Down Cards”. As such, the additional printed material 603 may be placed on the table with the cards 231 to remind the participants 230 of the changed rule. Furthermore, it is understood that the command 601 has encoded therein instructions for printing the additional printed material 603. In addition, as also depicted in FIG. 6, the processor 220 interacts 605 with the memory 222 to change the rules 223 to reflect the instruction of “All Players To Have TWO Face-Down Cards”.

In yet further examples, the processor 220 may change the rules 223 by adding a rule, rather than changing an existing rule 223. For example, the processor 220 may add a rule 223 that the played cards 232 may be kept by participants 230 and reused, and the like.

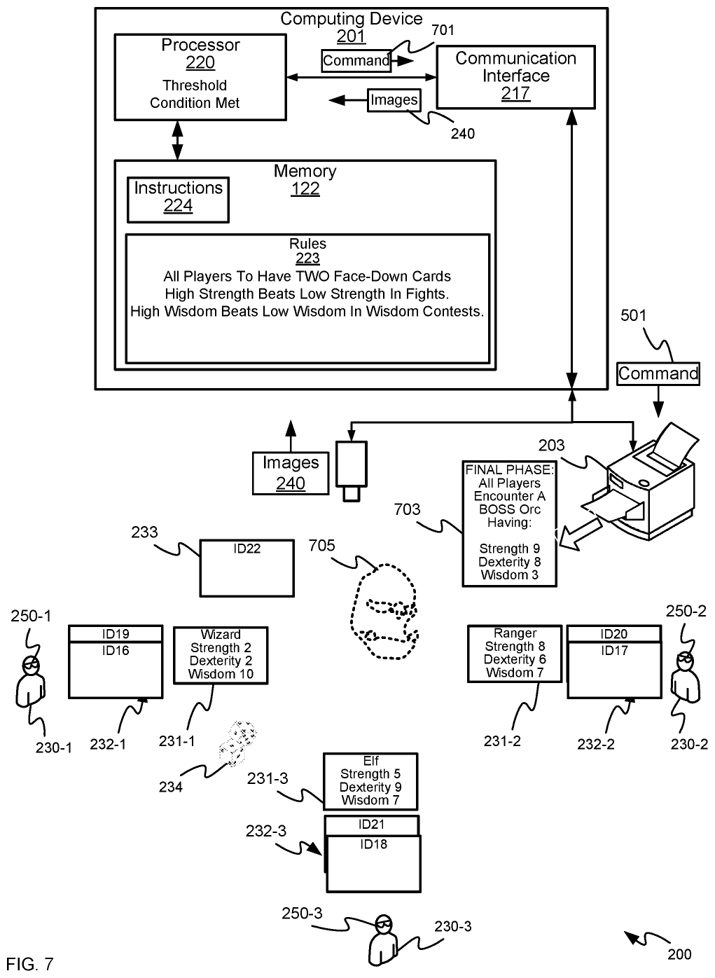

Attention is next directed to FIG. 7 which depicts another example of the method 400. FIG. 7 is substantially similar to FIG. 2 with like components having like numbers. In FIG. 7, the processor 220 is receiving the images 240 (e.g. at the block 401 of the method 400). However, in this example, game play has continued, relative to FIG. 6, and the participants 230 have continued to play the cards 232, and pick up cards 233 from the draw deck. In these examples, the processor 220 is generally monitoring a state of the game and/or event based on the printed materials used in the game and/or event, and a threshold condition of the method 400 may be related to the state of the event.

For example, as depicted, each participant 230 now has two face-down cards 232, and there is only one card 233 left in the draw deck. As such, the state of the game and/or event may be a final phase of the game and/or event.

In particular, the processor 220 may determine that if sequences of the cards 232 are played the rules 223 will be violated. For example, if sequences of the cards 232 left in the game are played one of the participants 230 may not be able to have two face-down cards as the draw deck has only one card 233 left. Such a state of the game and/or event may be a threshold condition related to a state of the game being in a “final phase”. The processor 220 may responsively and transmits a print command 701 to the printer 203 to control the printer 203 (e.g. at the block 407 of the method 400) to print additional printed material 703 that conforms to the rules 223 of the event, for example which will allow the game to be completed without the rule 223 of “All Players To Have TWO Face-Down Cards” being violated.

As depicted, in FIG. 7, the printer 203 responsively prints the additional printed material 703 in the form of a card with the instruction of “FINAL PHASE: All Players Encounter A BOSS Orc Having: Strength 9 Dexterity 8 Wisdom 3”. As such, the additional printed material 703 may be placed on the table with the other cards 231, 232, 233 such that the various characters of the cards 231 “fight” the character of the additional printed material 703 to end the game. Indeed, the information printed on the additional printed material 703 is generally to trigger a given state of the game and/or event, in particular, the final phase of the game.

The additional printed material 703 is printed in response to a state of the game and/or event, and to trigger a state of the game and/or event (e.g. the final phase). Furthermore, the characteristics of the character of the additional printed material 703 may be selected by the processor 220 such that the characters of the cards 232 may beat the character of the additional printed material 703 in a fight. Furthermore, it is understood that the command 701 has encoded therein instructions for printing the additional printed material 703.

Furthermore, the determination of the information printed on the additional printed material 703 may be based on the sequence of the printed materials that are to be played. For example the amount by which the characters strength is to be increased, as printed on the additional printed material 703, may be based on the sequence of cards 242-1, 242-2, 242-3. For example, the strength increase of “3” may be selected so that the characters of the cards 231 have a given and/or increased probability of winning the fights with the characters of the cards 242-1, 242-2, 242-3.

As also depicted in FIG. 7, the device 201 may also communicate with the augmented reality devices 250 to control the augmented reality devices 250 to provide an animation of printed materials used in the event. For example, as depicted in FIG. 7, an animation 705 of the character of the additional printed material 703 is provided (e.g. a head of the “Boss Orc”), the animation 705 depicted in outline in FIG. 7 to indicate that the animation 705 is visible only via the augmented reality devices 250. While not depicted, the animation 705 may further include animations of the characters of the cards 231, and which may further include an animation of the characters of the cards 231 fighting the character of the additional printed material 703.

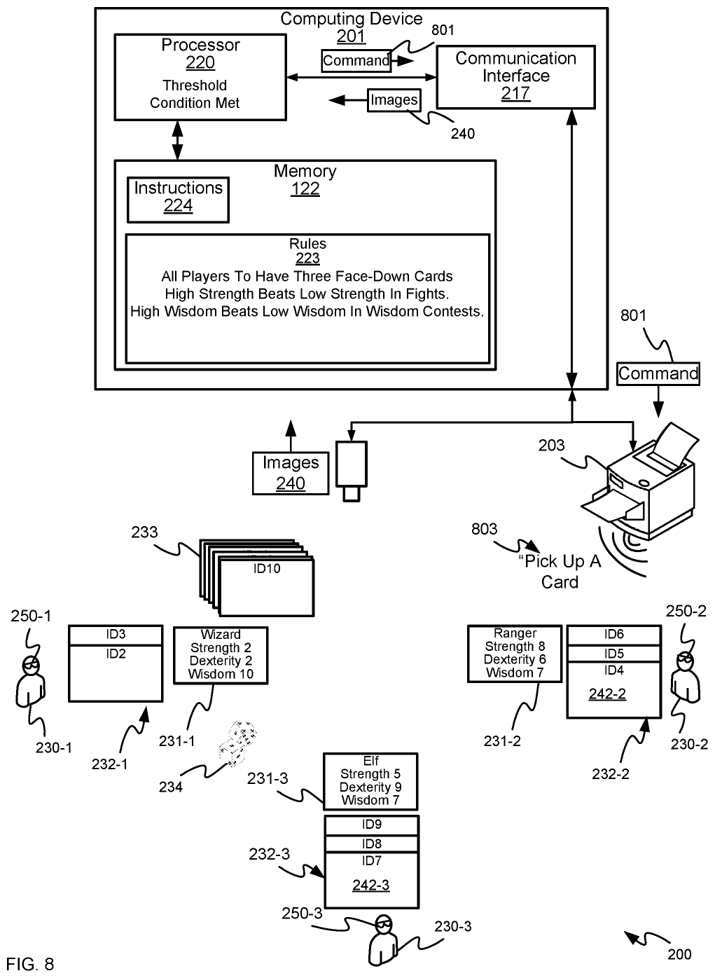

Attention is next directed to FIG. 8 which depicts further functionality of the device 201. FIG. 8 is substantially similar to FIG. 2 with like components having like numbers. However, in FIG. 8, the participant 230-1 has played a face-down card 232-1, but has not picked up a card 233 from the draw deck. Hence, the participant 230-1 has only two cards 232-1 left while the rules 223 indicate that each player (e.g. participant 230-1) is to have three face-down cards 232. As such, the processor 220 may: determine, from the images 240 acquired by the camera 202, that the rules 223 of the event are being violated; and, in response, transmit a command 801 to control the printer 203 to provide an alert 803. For example, as depicted, the command 801 causes a speaker of the printer 203 to emit sound indicating that the participant 230-1 should “Pick Up A Card”. However, the alert 803 may be in a visual format and/or haptic format. Indeed, the alert 803 may be provided by any suitable notification device of the printer 203. Alternatively, the alert 803 may be printed similar to the various additional printed material 503, 603, 703.

Furthermore, when the rules 223 have changed, as depicted in FIG. 6, the processor 220 may determine when the changed rules are being violated and responsively control the printer 203 to emit an alert.

Furthermore, the processor 220 may similarly control the printer 203 to interrupt the event and/or game by controlling the printer 203 to provide a notification similar to the alert 803, for example to indicate a break in game play, and the like.

Attention is next directed to FIG. 9 which depicts an alternative of the method 400. FIG. 9 is substantially similar to FIG. 7 with like components having like numbers. However, in FIG. 7, the printer 203 has been replaced with a three-dimensional printer 903. Hence, when the processor 220 determines that the threshold condition has been met, similar to as described above with respect to FIG. 7, the processor 220 controls the three-dimensional printer 903, via a command 911, to print a figurine 913 (e.g. the figurine 913 comprises additional printed materials) of the “BOSS Orc”. The figurine 913 include the same information as printed on the additional printed materials 703 and/or, as depicted, the device 201 may communicate with the augmented reality devices 250 to control the augmented reality devices 250 to provide an indication 915 of the information as printed on the additional printed materials 703. The indication 915 is depicted in outline in FIG. 9 to indicate that the indication 915 is visible only via the augmented reality devices 250.

While devices, systems and methods described heretofore have been with reference to event that include a game, in other examples, the method 400 and/or the devices 101, 201 may be adapted for use for other events.

For example, a device similar to the devices 101, 201 may implement the method 400 and communicate with a camera and a printer, the device to monitor, using the camera, a live instance of an event that relies on printed materials such as a job interview, a legal disposition, a negotiation and the like, and which proceeds according to rules stored in a memory. Based on the quality or completeness of responses (e.g. on a sequence of printed materials, but which may also include verbal and/or visual responses), the device may control the printer to provide a customized script of new questions (e.g. interrogation questions) for use by an interviewer. Such questions may ensure asking of certain questions by the interviewer (and which may be printed with instructions of how the questions are to be asked) and/or include challenge questions to be provided by the interviewee, for example to fill certain declared skills (e.g. in a job interview). Such questions may comply with the stored rules which may define human resources policies and/or laws. Or, similarly, during a negotiation, a set of “offers” may be printed, which comply with a company's stored rules for discounts or payment terms, but may be adapted in real time based on the give-and-take of a sequence of printed materials of the negotiation.

It should be recognized that features and aspects of the various examples provided above may be combined into further examples that also fall within the scope of the present disclosure.

1. A computing device comprising:
a communication interface to communicate with a camera and a printer; and
a processor connected to the communication interface and a memory storing rules of an event that relies on printed materials, the processor to execute instructions stored in the memory, the instructions to:
monitor, using the camera, a live instance of the event that relies on the printed materials;
determine, from images acquired by the camera, that a sequence of the printed materials used in the event by participants meets a threshold condition that conforms to the rules of the event, as stored in the memory; and, in response,
control the printer to print additional printed material that conforms to the rules of the event, as stored in the memory, the additional printed material used to alter the event according to the rules, the additional printed material unassigned to any of the participants in the event.

2. The computing device of claim 1, wherein the printed materials used in the event are playing cards, and the additional printed material includes an additional playing card.

3. The computing device of claim 1, wherein the printed materials used in the event are three-dimensional figures, and the additional printed material includes an additional three-dimensional figure, the printer comprising a three-dimensional printer.

4. The computing device of claim 1, wherein the instructions are further to determine, from the images acquired by the camera, the sequence of the printed materials from a backside of each of the printed materials, the backside of each of the printed materials comprising an indication of a respective face side of the printed materials.

5. The computing device of claim 1, wherein the instructions are further to monitor a state of the event based on the printed materials used in the event, the threshold condition related to the state of the event.

6. A non-transitory machine-readable storage medium encoded with instructions executable by a processor radio of a computing device, the non-transitory machine-readable storage medium comprising:
instructions to: monitor, using a camera, a live instance of an event that relies on printed materials;
instructions to: determine, from images acquired by the camera, that a sequence of the printed materials used in the event meets a threshold condition that conforms to rules of the event, as stored in a memory; and, in response,
instructions to: control a printer to print additional printed material that conforms to the rules of the event, as stored in the memory, the additional printed material used to alter the event according to the rules and according to information printed on the additional printed material, the additional printed material unassigned to any participants in the event.

7. The non-transitory machine-readable storage medium of claim 6, further comprising instructions to: determine the information printed on the additional printed material based on the sequence of the printed materials.

8. The non-transitory machine-readable storage medium of claim 6, further comprising instructions to: determine the information printed on the additional printed material based on the sequence of the printed materials and the rules of the event, as stored in the memory, the information to trigger a given state of the event.

9. The non-transitory machine-readable storage medium of claim 6, further comprising instructions to: monitor a state of the event based on the printed materials used in the event, the threshold condition related to the state of the event.

10. The non-transitory machine-readable storage medium of claim 6, further comprising instructions to: monitor a state of the event based on the printed materials used in the event, the threshold condition related to the state of the event, the state of the event being a final phase of the event.

11. A computing device comprising:
a communication interface to communicate with a camera and a printer; and
a processor connected to the communication interface and a memory storing rules of an event that relies on printed materials, the processor to execute instructions stored in the memory, the instructions to:
monitor, using the camera, a live instance of the event that relies on the printed materials;
determine, from images acquired by the camera, that a sequence of the printed materials used in the event meets a threshold condition that conforms to the rules of the event, as stored in the memory; in response,
control the printer to print additional printed material that conforms to the rules of the event, as stored in the memory, the additional printed material used to change the rules of the event; and
store changed rules of the event in the memory.

12. The computing device of claim 11, wherein the instructions are further to:
determine, from images acquired by the camera, that the rules of the event or the changed rules of the event are being violated; and, in response,
control the printer to provide an alert.

13. The computing device of claim 11, wherein the communication interface is further to communicate with an augmented reality device used by a participant in the event, and wherein the instructions are further to:
control the augmented reality device to provide an animation of the printed materials used in the event.

14. The computing device of claim 11, wherein the instructions are further to:
control the printer to interrupt the event by providing a notification.

15. The computing device of claim 11, wherein the instructions are further to determine, from the images acquired by the camera, the sequence of the printed materials from a backside or a face side of each of the printed materials, the backside of each of the printed materials comprising an indication of a respective face side of the printed materials.
